(19) United States
(12) Patent Application Publication
(10) Pub. No.: US 2006/0032367 A1
(43) Pub. Date: Feb. 16, 2006

(54) Keyboard device for an electronic musical instrument

(76) Inventor: Chun-Kuan Lin, Taipei City (TW)

Correspondence Address: CHRISTIE, PARKER & HALE, LLP, PO BOX 7068, PASADENA, CA, 91109-7068, US

(21) Appl. No.: 10/916,686

(22) Filed: Aug. 11, 2004

(51) Int. Cl. G10H 1/34; G10H 3/00

(52) U.S. Cl. 84/745

(57) ABSTRACT

A keyboard device for an electronic musical instrument includes a frame, a key mounted to the frame, and a circuit board. The key has a front operating portion and a rear actuating portion, and is tiltable from a normal rest position to a lower stop position in response to a stroking action at the front operating portion. The rear actuating portion has a topside that is provided with an actuator. The circuit board is mounted to the frame, is disposed above the rear actuating portion of the key, and has a lower surface provided with a contact. The actuator actuates the contact when the key is tilted to the lower stop position.

### BACKGROUND OF THE INVENTION

1. Field of the Invention

The invention relates to an electronic musical instrument, more particularly to a keyboard device for an electronic musical instrument.

2. Description of the Related Art

Referring to FIG. 1, a conventional keyboard device 1 for an electronic musical instrument is shown to include a frame 2, a set of keys 21 (only one is shown) mounted to the frame 2, and a circuit board 23 for tone generation control. Each key 21 has a front operating portion 210 and a rear pivot portion 211. Each of a set of pivot joints 20 (only one is shown) is mounted to the frame 2, and connects tiltably the rear pivot portion 211 of a respective key 21 to the frame 2. Accordingly, each key 21 is tiltable from a normal rest position (see FIG. 1) to a lower stop position (see FIG. 2) in response to a stroking action at the front operating portion 210. In addition, each key 21 is biased toward the normal rest position by a corresponding biasing member 22, which is mounted to the frame 2 and which biases the front operating portion 210 of the respective key 2 upwardly. Moreover, the front operating portion 210 of each key 21 has a bottom side that is provided with an actuator 24. The circuit board 23 is mounted to the frame 2, is disposed under the front operating portions 210 of the keys 21, and has a top surface provided with a set of contacts 230 (only one is shown). The actuator 24 on each key 21 actuates a corresponding contact 230 on the circuit board 23 when the respective key 21 is tilted to the lower stop position such that a corresponding musical tone is electrically produced by the electronic musical instrument in a manner well known in the art.

In the conventional keyboard device 1, because the circuit board 23 is disposed under the keys 21, the circuit board 23 gets wet when water is spilled by accident on the keys 21, which can result in damage to the keyboard device 1.

### SUMMARY OF THE INVENTION

Therefore, the object of the present invention is to provide a keyboard device for an electronic musical instrument that can overcome the aforesaid drawback of the prior art.

According to this invention, a keyboard device for an electronic musical instrument includes a frame, a key mounted to the frame, and a circuit board. The key has a front operating portion and a rear actuating portion, and is tiltable from a normal rest position to a lower stop position in response to a stroking action at the front operating portion. The rear actuating portion has a top side that is provided with an actuator. The circuit board is mounted to the frame, and is disposed above the rear actuating portion of the key. The circuit board has a lower surface provided with a contact. The actuator actuates the contact when the key is tilted to the lower stop position.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional keyboard device for an electronic musical instrument, illustrating a key thereof in a normal rest position;

FIG. 2 is a view similar to FIG. 1, illustrating the key in a lower stop position;

FIG. 3 is a sectional view of the preferred embodiment of a keyboard device for an electronic musical instrument, illustrating a key thereof in a normal rest position; and

FIG. 4 is a view similar to FIG. 3, illustrating the key in a lower stop position.

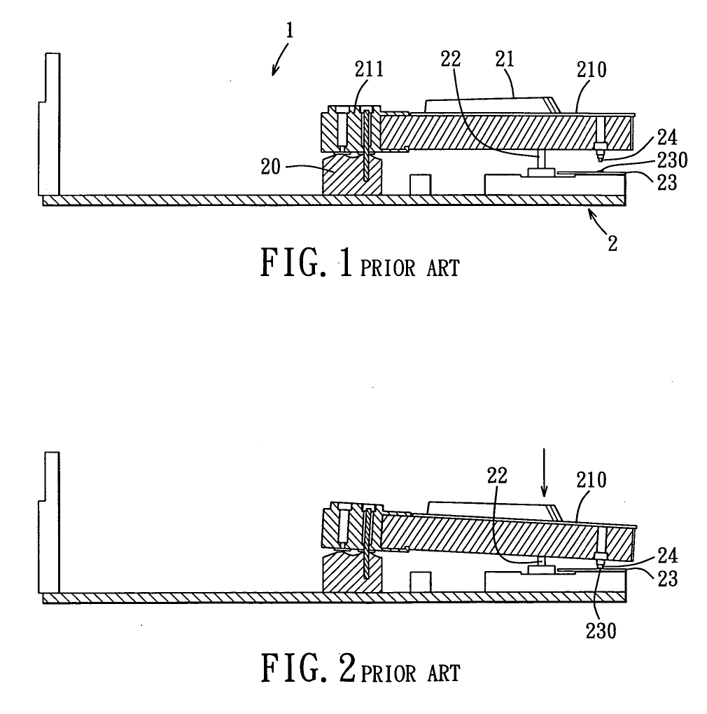

### DETAILED DESCRIPTION OF THE PREFERRED EMBODIMENT

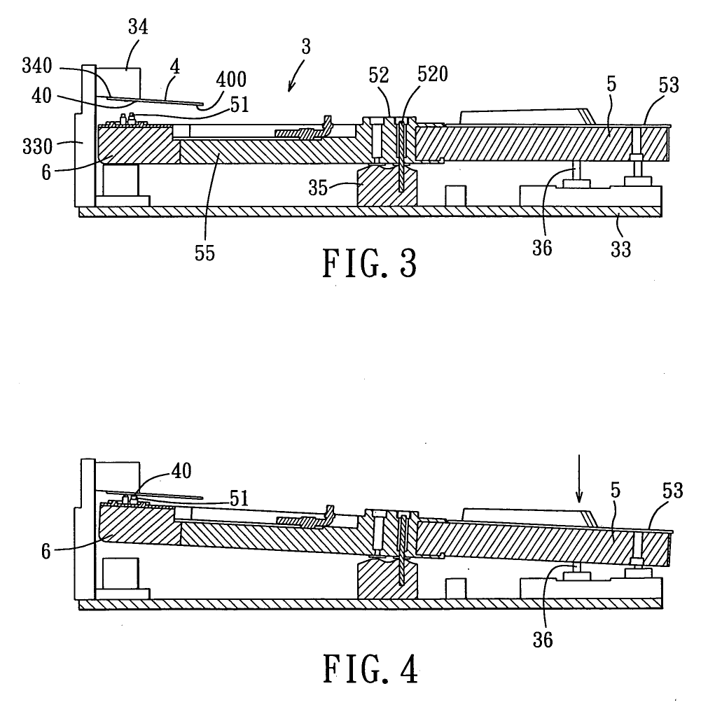

Referring to FIG. 3, the preferred embodiment of a keyboard device 3 for an electronic musical instrument is shown to include a frame 33, a set of keys 5 (only one is shown) mounted to the frame 33, and a circuit board 44 for tone generation control. Each key 5 has a front operating portion 53, a rear actuating portion 55, and an intermediate pivot portion 52 between the front operating portion 53 and the rear actuating portion 55. Each of a set of pivot joints 35 (only one is shown) is mounted to the frame 33, and includes a flexible pin 520 to connect tiltably the intermediate pivot portion 52 of a respective key 5 to the frame 33. Accordingly, each key 5 is tiltable from a normal rest position (see FIG. 3) to a lower stop position (see FIG. 4) in response to a stroking action at the front operating portion 53. In addition, each key 5 is biased toward the normal rest position by a corresponding biasing member 36, which is mounted to the frame 33 and which biases the front operating portion 53 of the respective key 5 upwardly, and by a weight member 6 provided on the rear actuating portion 55 of the key 5. As a result, each key 5 can be restored quickly to the normal rest position at the end of the stroking action. Moreover, the rear actuating portion 55 of each key 5 has a top side that is provided with an actuator 51. The circuit board 4 is mounted to the frame 33, and is disposed above the rear actuating portions 55 of the keys 5. In this embodiment, the frame 33 includes an upright rear wall 330, and a beam 34 is mounted on a top end of the rear wall 330. The circuit board 4, which is secured to a lower side 340 of the beam 34, has a lower surface 400 provided with a set of contacts 40 (only one is shown). The actuator 51 on each key 5 actuates a corresponding contact 40 on the circuit board 4 when the respective key 5 is tilted to the lower stop position such that a corresponding musical tone is electrically produced by the electronic musical instrument in a manner well known in the art.

In the keyboard device 3 of this invention, because the circuit board 4 is disposed above the rear actuating portions 55 of the keys 5, the circuit board 4 is prevented from getting wet when water is spilled by accident on the keys 5, thereby protecting the keyboard device 3 from damage.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A keyboard device for an electronic musical instrument, comprising:
a frame;
a key mounted to said frame, said key having a front operating portion and a rear actuating portion and being tiltable from a normal rest position to a lower stop position in response to a stroking action at said front operating portion, said rear actuating portion having a top side that is provided with an actuator; and
a circuit board mounted to said frame and disposed above said rear actuating portion of said key, said circuit board having a lower surface provided with a contact, said actuator actuating said contact when said key is tilted to the lower stop position.

2. The keyboard device of claim 1, wherein said key further has an intermediate pivot portion between said front operating portion and said rear actuating portion,
said keyboard device further comprising a pivot joint mounted to said frame and connecting tiltably said intermediate pivot portion of said key to said frame.

3. The keyboard device of claim 2, wherein said rear actuating portion of said key is provided with a weight member.

4. The keyboard device of claim 3, further comprising a biasing member mounted to said frame and biasing said front operating portion of said key upwardly, thereby biasing said key toward the normal rest position.

5. The keyboard device of claim 2, further comprising a biasing member mounted to said frame and biasing said front operating portion of said key upwardly, thereby biasing said key toward the normal rest position.
